(19) United States
(12) Patent Application Publication
(10) Pub. No.: US 2006/0282684 A1
(43) Pub. Date: Dec. 14, 2006

(54) Imaging apparatus and storage medium

(76) Inventors: Akihiro Kakoi, Kanagawa (JP); Tomoaki Yano, Kanagawa (JP); Tetsuo Asakawa, Tokyo (JP); Miki Kouchi, Kanagawa (JP); Rie Nakamura, Tokyo (JP); Yoshinori Furuichi, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/435,148

(22) Filed: May 17, 2006

(30) Foreign Application Priority Data
Jun. 9, 2005 (JP) 2005-169411

(51) Int. Cl. G06F 12/14; G06F 17/30; H04L 9/32; G06F 12/00; G06F 7/04; G06F 11/30; G06F 13/00; G06K 9/00; H03M 1/68; G06F 7/58; H04K 1/00; G06K 19/00; H04L 9/00; G11C 7/00; H04N 7/16

(52) U.S. Cl. 713/193; 726/17; 726/27

(57) ABSTRACT

An imaging apparatus is disclosed that includes an authentication information storage unit configured to store first authentication information used for authenticating a storage medium, an authentication unit configured to perform an authentication process on the storage medium based on second authentication information stored in the storage medium and the first authentication information stored in the authentication information storage unit, and an access unit that is configured to perform at least one of reading digital data from the storage medium and writing the digital data on the storage medium when the authentication unit authenticates the storage medium.

### BACKGROUND OF THE INVENTION

1. Field of the Invention

The present invention relates to an imaging apparatus that authenticates a storage medium based on authentication information and a storage medium storing authentication information.

2. Description of the Related Art

A digital camera that is capable of storing image data of a captured image as digital data is becoming increasingly popular. In the case of using such a digital camera, an image captured by the digital camera may be printed by a printer without using a personal computer, for example (e.g., see Japanese Laid-Open Patent Publication No. 2002-240361).

FIG. 1 is a diagram showing an exemplary configuration of an imaging apparatus 3 that is connected to a digital camera 1 via a cable 2. Image data of an image captured by the digital camera 1 are input to the imaging apparatus 3 via the cable 2 or a removable medium 5, for example. The image data input to the imaging apparatus 3 are stored in a predetermined format (e.g., DPOF: Digital Print Order Format), and the imaging apparatus 3 is configured to print a designated number of copies of the designated image data according to this format. In this way, the imaging apparatus 3 may print an image without using a personal computer.

It is noted that with the growing interest in ensuring security of data and information, a so-called secure printing technique is being developed in which authentication has to be performed upon printing image data with an imaging apparatus (e.g., see Japanese Laid-Open Patent Publication No. 2002-240361). According to the secure printing technique, a large capacity storage apparatus that includes a large-scale content server is used for establishing connection with an imaging apparatus via a network and storing print data in the imaging apparatus. Also, an authentication server is included in the large capacity storage apparatus as a separate server from the content server which authentication server is used to perform user authentication to thereby realize secure printing.

However, ensuring security of image data captured by a digital camera has not been considered. Thereby, when a digital camera or a storage medium storing image data captured by a digital camera falls into the hands of a third person, the stored image data may be printed by an imaging apparatus used by the third person.

It is noted that using a content server according to the secure printing technique as is described above in a household appliance such as the digital camera is not practical since operation and maintenance of the content server are required leading to cost increase, and installation and setup of the content server is quite complicated.

Yet the storage capacity of a storage medium used in a digital camera is expected to increase so that large capacity/high quality image data may be handled. Accordingly, image data captured by a digital camera are preferably printed with due consideration for security.

### SUMMARY OF THE INVENTION

According to an embodiment of the present invention, an imaging apparatus is provided that is configured to read/write information from/on a storage medium while ensuring security of the information at a relatively low cost. According to another embodiment of the present invention, a storage medium is provided that is capable of ensuring security of information stored therein when the information is accessed by an imaging apparatus.

According to one specific embodiment of the present invention, an imaging apparatus is provided that includes:

an authentication information storage unit configured to store first authentication information used for authenticating a storage medium;

an authentication unit configured to perform an authentication process on the storage medium based on second authentication information stored in the storage medium and the first authentication information stored in the authentication information storage unit; and

an access unit that is configured to perform at least one of reading digital data from the storage medium and writing the digital data on the storage medium when the authentication unit authenticates the storage medium.

According to a preferred embodiment of the present invention, the authentication unit authenticates the storage medium when the second authentication information matches the first authentication information.

According to another preferred embodiment of the present invention, the digital data correspond to image data captured by a solid-state image sensing device. In another embodiment, the digital data may correspond to music data such as MP3 data or image data such as MPEG data.

According to another preferred embodiment of the present invention, the first authentication information and the second authentication information correspond to imaging apparatus-specific code information.

According to another preferred embodiment of the present invention, the first authentication information and the second authentication information correspond to encryption scheme identification information that identifies an encryption scheme used for encrypting the digital data.

According to another preferred embodiment of the present invention, the first authentication information and the second authentication information correspond to group identification information that identifies a group to which the storage medium is assigned.

According to another specific embodiment of the present invention, a storage medium is provided that includes a tree structure in which digital data are stored, the tree structure including a predetermined directory in which authentication information used by an imaging apparatus is stored.

### BRIEF DESCRIPTION OF THE DRAWINGS

FIG. 1 is a diagram showing an imaging apparatus that is connected to a digital camera via a cable;

FIG. 2 is a block diagram showing a configuration of an imaging apparatus according to an embodiment of the present invention;

FIG. 3 is a diagram showing an exemplary directory structure realized in a removable medium according to an embodiment of the present invention;

FIG. 4 is a table representing exemplary information including a machine code stored in a NVRAM of an imaging apparatus according to an embodiment of the present invention;

FIG. 5 is a diagram showing an example of an authentication information file of a removable medium according to an embodiment of the present invention storing a machine code;

FIG. 6 is a table representing encryption scheme IDs in association with their corresponding encryption schemes included in a NVRAM of an imaging apparatus according to an embodiment of the present invention;

FIG. 7 is a diagram showing an example of an authentication information file of a removable medium according to an embodiment of the present invention storing an encryption scheme ID;

FIG. 8 is a table representing exemplary information including a group ID stored in a NVRAM of an imaging apparatus according to an embodiment of the present invention;

FIG. 9 is a diagram showing an example of an authentication information file of a removable medium according to an embodiment of the present invention storing a group ID;

FIG. 10 is a table representing determinations on whether to authenticate a removable medium depending on whether the group ID stored in the authentication information file of the removable medium matches the group ID stored in the NVRAM of the imaging apparatus; and

FIG. 11 is a flowchart illustrating an authentication process performed on a removable medium by an imaging apparatus according to an embodiment of the present invention.

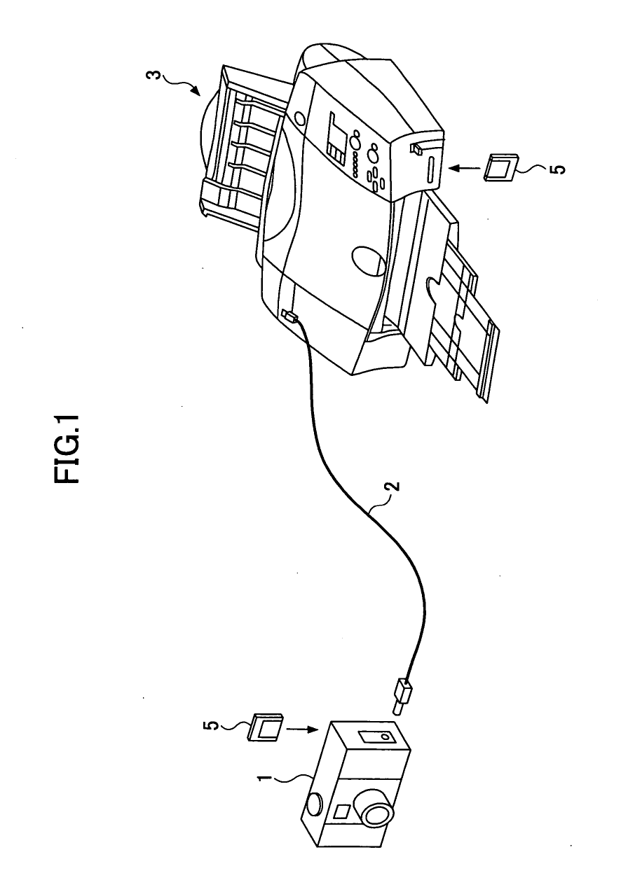

### DESCRIPTION OF THE PREFERRED EMBODIMENTS

In the following, preferred embodiments of the present invention are described with reference to the accompanying drawings.

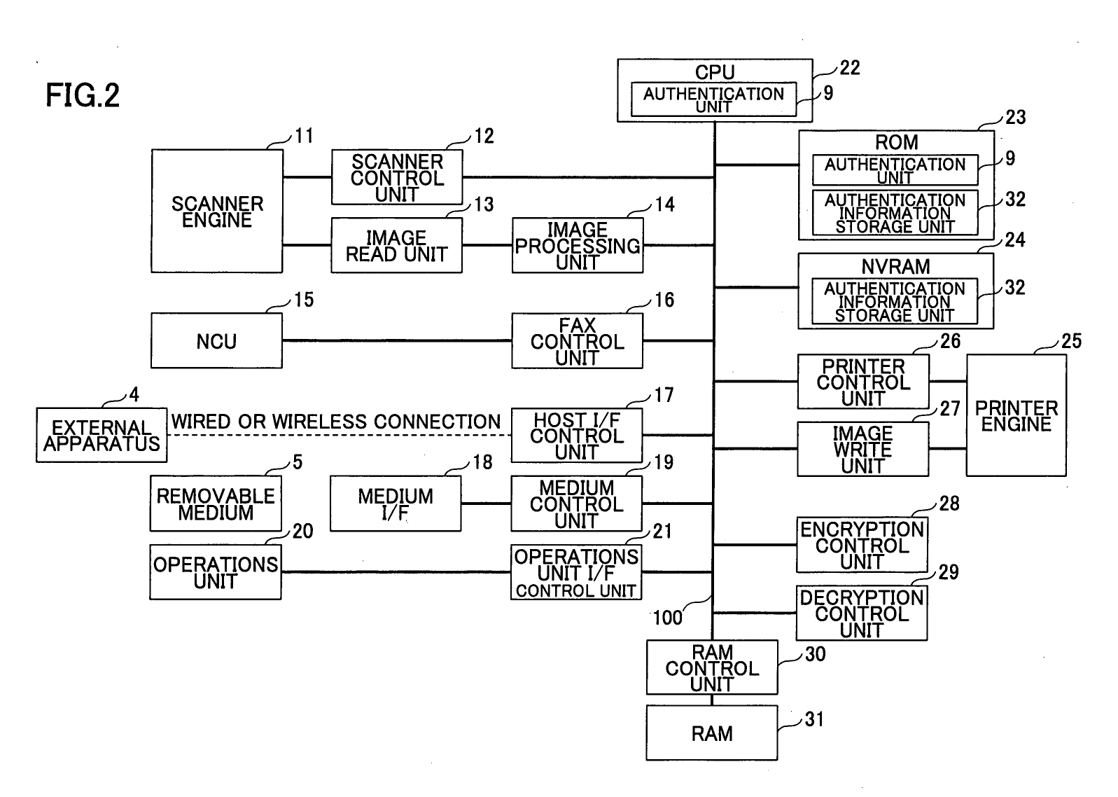

FIG. 2 is a block diagram showing a configuration of an imaging apparatus according to an embodiment of the present invention. The imaging apparatus shown in FIG. 2 is a multifunction printer (MFP) having plural imaging functions such as an image scanning function, a copying function, a facsimile function, and a printing function. However, an imaging apparatus according to an embodiment of the present invention is not limited to a multifunction printer, and may also be an imaging apparatus with a single imaging function such as a facsimile machine or a printer, for example.

The imaging apparatus of the present embodiment has the so-called direct printing function for reading image data directly from a storage medium (referred to as removable medium hereinafter) and printing the read image data. The imaging apparatus of the present embodiment is configured to authenticate a removable medium 5 based on whether authentication information is stored in the removable medium 5. In this way, image data stored in the removable medium 5 may be prevented from being printed or stored by an arbitrary imaging apparatus so that security of the image data stored in the removable medium 5 may be ensured in a case where a third person gets hold of the removable medium 5.

In the imaging apparatus of the present embodiment, image scanning is realized by a scanner engine 11, a scanner control unit 12, an image reading unit 13, and an image processing unit 14. The scanner engine 11 is configured to optically scan a document. Specifically, the scanner engine 11 irradiates light on the document and inputs reflected light of the irradiated light to an image capturing device such as a CCD that converts the input light into an electrical signal. The scanner engine 11 may be adapted for a flat bed scanner or a document feeding scanner that feeds a document to a fixed light source, for example.

The scanner control unit 12 is configured to control the moving speed of the light source and the paper feeding operation, and transmit the reflected light input from the scanner engine 11 to the image reading unit 13. The image reading unit 13 is configured to perform an A/D conversion process on the electrical signal converted from the reflected light, and transmit the digitally converted signal as digital data to the image processing unit 14. The image processing unit 14 is configured to perform image processes such as shading, scaling, edge processing, gamma (γ) correction, and/or a binarization, and transmit the processed image data to a RAM control unit 30 via a bus 100. The RAM control unit 30 is configured to temporarily store processing image data in a RAM 31.

Also, the imaging apparatus of the present embodiment includes a host interface (I/F) control unit 17 that is configured to receive image data to be printed (print data) from an external apparatus 4. The external apparatus 4 may be an apparatus that stores image data such as a digital camera, a cell phone, a personal computer, or a PDA (personal data assistant), for example. The host I/F control unit 17 may be configured to control an interface such as a printer port (IEEE 1284), a USB (Universal Serial Bus), or an IEEE 1394 port, for example. The connection realized by the interface may be any type of connection such as local connection, network connection, wired connection, or wireless connection, for example.

Upon receiving image data from the external apparatus 4, the host I/F control unit 17 temporarily stores the received image data in the RAM 31 via the RAM control unit 30. According to the present embodiment, the host I/F control unit 17 is configured to receive the image data and store the received image data in a case where the removable medium 5 is installed in the external apparatus 4 and the removable medium 5 has authentication information stored therein, for example.

Also, the imaging apparatus according to the present embodiment includes a medium I/F 18 into which the removable medium 5 is loaded and a medium control unit 19 for controlling operations performed on the removable medium 5. The removable medium 5 is configured to store image data captured by a digital camera, for example, and may be a CF (Compact Flash (registered trademark)), an SD card, a mini SD card, a MMC (Multimedia Card), a xD picture card, a memory stick (registered trademark), USB memory, a CD, or a DVD, for example. However, the removable medium 5 is not limited to the above exemples, and other types of storage media for storing image data and supplying the image data to an imaging apparatus may be used as well.

The medium I/F 18 is configured to physically connect to the removable medium 5 and read image data that are electrically, magnetically, or optically stored in the removable medium 5. The medium control unit 19 is configured to detect the removable medium 5 when it is loaded into the medium I/F 18, and control operations such as image data reading operations according to the detected removable medium 5, for example. Specifically, if authentication information is stored in the removable medium 5 the medium control unit 19 may control reading/writing of image data from/on the removable medium 5. In the case of reading image data from the removable medium 5, the medium control unit 19 temporarily stores the read image data in the RAM 31 via the RAM control unit 30.

It is noted that the host I/F control unit 17 and the medium control unit 19 may realize an access unit according to an embodiment of the present invention for reading/writing digital data from/on the removable medium 5.

Also, the imaging apparatus of the present embodiment includes a fax control unit 16 and a NCU (Network Control Unit) 15. The fax control unit 16 is configured to realize facsimile transmission/reception via the NCU 15. Specifically, the fax control unit 16 is configured to perform signal processing such as data compression and/or modulation on image data comprising two-dimensional information of a black/white or halftone image and transmit the signal-processed image data to a communication counterpart via a public communications network. Also, the fax control unit 16 is configured to receive image data transmitted from a communication counterpart and decode the received image data into two-dimensional information through modulation and data decompression, for example. The NCU 15 is configured to transmit a telephone number (dial signal) for calling a communication counterpart upon connecting to the public communications network. In facsimile reception, the telephone number of the imaging apparatus is designated from the public communications network and connection with the communication counterpart is allowed. It is noted that image data received by the fax control unit 16 are temporarily stored in the RAM 31 via the RAM control unit 30.

Also, the imaging apparatus of the present embodiment includes a printer engine 25, a printer control unit 26, and an image write unit 27. The printer engine 25 is configured to print image data read by the scanner engine 11, image data received by the fax control unit 16, image data transmitted from the external apparatus 4, and image data read from the removable medium 5, for example. It is noted that the imaging apparatus according to the present embodiment has a direct printing function for directly printing image data stored in the removable medium 5 without connecting to the external apparatus 4.

The printer control unit 26 is configured to acquire designated image data from the RAM 31 and transmit the acquired image data to the image write unit 27 via the bus 100. The image write unit 27 is configured to control the printer engine 25 to generate an image according to the imaging scheme employed by the printer engine 25. It is noted that the printer engine 25 may employ the laser imaging scheme, the LED imaging scheme, the liquid crystal shutter imaging scheme, the inkjet imaging scheme, or any other suitable imaging scheme.

Also, the imaging apparatus of the present embodiment includes an encryption control unit 28 and a decryption control unit 29 that are configured to control operations relating to encryption and decryption of image data. The encryption control unit 28 is configured to encrypt image data using a user-specific encryption key or an encryption key generated for the image data, and manage the encrypted image data, user information, and the encryption key, for example. The decryption control unit 29 is configured to decrypt the encrypted image data using a decryption key corresponding to the encryption key used to encrypt the image data, for example.

Also, the imaging apparatus of the present embodiment includes an operations unit 20, an operations unit I/F control unit 21, a CPU 22, a ROM 23, and a NVRAM 24. The operations unit 20 corresponds to machine interfaces through which a user may monitor and control operations of the imaging apparatus. The operations unit 20 may include buttons and a touch panel for making operations commands, an indicator (e.g., display devices such as a LED or LCD) for displaying the operating status of the imaging apparatus, and a speaker, for example. The operations unit I/F control unit 21 is configured to monitor the operations unit 20 to determine the operations performed by the user via the operations unit 20 and inform the CPU 22 of the user operations.

The CPU 22 is configured to control and issue commands to the respective units of the imaging apparatus according to the user operations, for example. The ROM 23 stores programs that are to be executed by the CPU 22. When the power is turned on, the CPU 22 loads the programs, and transmits control signals to the printer control unit 26, for example. It is noted that the present invention is not limited to use of a single CPU 22 and plural CPUs may also be used.

The ROM 23 stores programs for enabling the CPU 22 to function as an authentication unit 9. The authentication unit 9 is configured to refer to authentication information stored in the NVRAM 24 or ROM 23 to determine whether to authenticate the removable medium 5 based on the authentication information stored in the removable medium 5.

The RAM control unit 30 is configured to receive image data and command signals issued by the CPU 22, for example, and temporarily store processing data of the respective units of the imaging apparatus. The NVRAM 24 stores authentication information for authenticating the removable medium 5 and information specific to the imaging apparatus (e.g., counter value information pertaining to a number of copies). It is noted that the authentication information may alternatively be stored in the ROM 23.

In the following, a directory structure of the removable medium 5 according to an embodiment of the present invention is described.

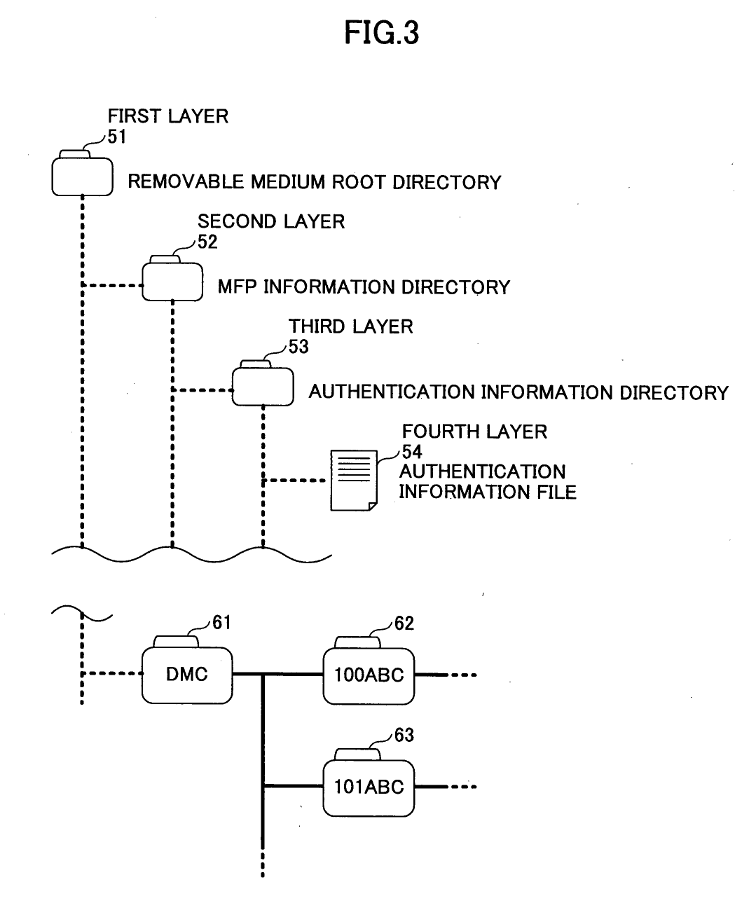

FIG. 3 is a diagram showing an exemplary directory structure of the removable medium 5. In the removable medium 5 according to the present embodiment, a hierarchial structure is realized by a root directory 51 and subordinate directories branching out from the root directory 51 arranged into a tree-like structure. It is noted that image data are stored in directories at a lower hierarchial layer than a DCM directory 61. For example, a 100ABC directory 62 and a 101ABC directory 63 may branch out from the DCM directory 61 as subordinate directories of the DCM directory 61, and image data may be successively stored in the 100ABC directory 62 and the 101ABC directory 63 according to the order in which the image data are captured. In the case of implementing the direct printing function, the image data are preferably recorded in a predetermined format such as the DCF (design rule for camera file) system or the DPOF (digital print order format). In the case of storing the image data according to DPOF, image data to be printed and a designated number of copies are stored in the removable medium 5.

Also, the directory structure of the removable medium 5 according to the present embodiment includes a hierarchial structure that is realized by directories for storing authentication information that branch out from the root directory 51. For example, given that the root directory 51 corresponds to a first layer, a MFP (multifunction directory) information directory 52 is provided as the second layer, and an authentication information directory 53 is provided as the third layer. Also, an authentication information file 54 is stored in the fourth layer.

The authentication information directory 53 is a predetermined directory that the imaging apparatus refers to when the removable medium 5 is loaded into the medium I/F 18. Specifically, upon detecting the removable medium 5, the imaging apparatus detects the MFP information directory 52 under the root directory 51 of the removable medium 5 if the removable medium 5 includes such a directory.

If the MFP information directory 52 is detected, the imaging apparatus detects the authentication information directory 53 under the MFC information directory 52 if the removable medium 5 includes such a directory, and reads the authentication information file 54 stored under the authentication information directory 53.

In the present embodiment, the authentication unit 9 is configured to authenticate the removable medium 5 if authentication information as is described below is stored in the authentication file 54 of the removable medium 5 and this authentication information matches authentication information stored in the ROM 23 or NVRAM 24 of the imaging apparatus.

In the following, the authentication information is described in detail.

As is described above, the imaging apparatus includes the NVRAM 24 that stores information specific to the imaging apparatus such as counter value information pertaining to a number of copies and a number specific to the imaging apparatus such as the so-called machine code (imaging apparatus-specific code) that may be a serial number or a production number assigned to the imaging apparatus, for example. The machine code corresponds to a non-overlapping number that is assigned to the imaging apparatus during its manufacture. The machine code may be used to track down problems occurring during manufacture of the imaging apparatus and identify each imaging apparatus that is manufactured.

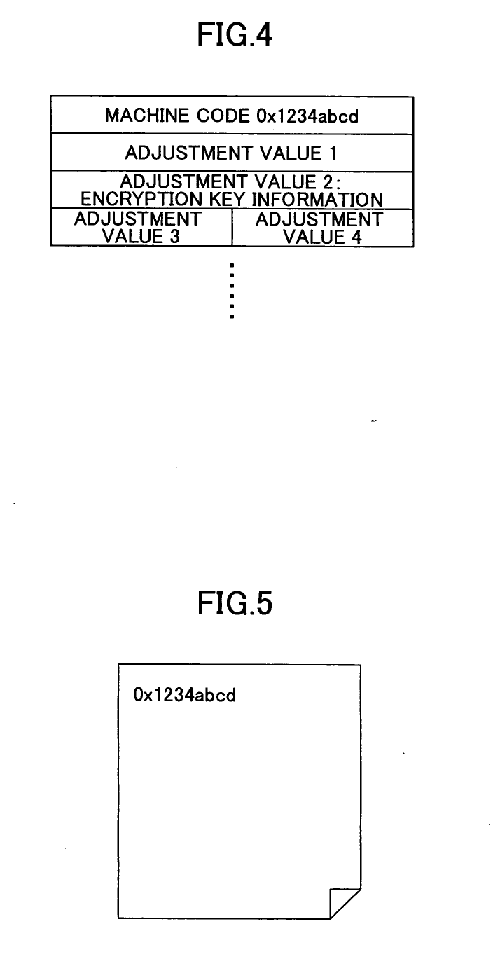

FIG. 4 is a table illustrating exemplary information including a machine code that is stored in the NVRAM 24. As is shown in this drawing, the NVRAM 24 stores a machine code and adjustment values 1-4 in a predetermined format. In the present example, ‘0x1234abcd’ is registered as the machine code and encryption key information is registered as adjustment value 2. It is noted that information specific to the imaging apparatus that is to be constantly held such as information used for maintenance of the imaging apparatus (e.g., the number of copies and the operating time of the imaging apparatus) is stored as the adjustment value.

As is described above, since the machine code corresponds to a specific number assigned to each imaging apparatus, the machine code of an imaging apparatus may be used as authentication information for authenticating the removable medium 5. Specifically, by recording the machine code of a certain imaging apparatus on the removable medium 5, the removable medium 5 may be prevented from being authenticated by other imaging apparatuses. According to the present embodiment, the authentication unit 9 of a relevant imaging apparatus is configured to authenticate the removable medium 5 and read image data therefrom if the machine code of the relevant imaging apparatus is stored in the authentication information file 54 of the removable medium 5.

It is noted that the machine code of the relevant imaging apparatus may be recorded on the removable medium 5 by loading the removable medium 5 into the medium I/F 18 or connecting the host I/F control unit 17 to the external apparatus 4, and recording the machine code of the relevant imaging apparatus on the authentication information file 54 of the removable medium 5 through user operations directed by a user via the operations unit 20, for example. In one preferred embodiment, user authentication may be performed upon recording the machine code on the removable medium 5.

FIG. 5 is a diagram illustrating an example of the authentication information file 54 of the removable medium 5 storing a machine code. By recording the machine code of the relevant imaging apparatus on the removable recording medium 5 as is illustrated in FIG. 5, image data captured by a digital camera or a cell phone that are stored in the removable medium 5 may be read by the relevant imaging apparatus. However, the image data stored in the removable medium 5 may not be read by other imaging apparatuses so that security of the image data may be ensured in a case where the removable medium gets into the hands of a third person.

In the following, authentication information according to another embodiment of the present invention is described.

According to the present embodiment, the authentication information corresponds to identification information for identifying an encryption scheme. In a case where the confidentiality of captured image data is high, the captured image data may be encrypted by a digital camera that captures the image data or image data managing software. It is noted that image data may be encrypted using various encryption schemes including the DES (data encryption standard), 3DES (triple data encryption standard), AES (advanced encryption standard), and PGP (pretty good privacy), for example. In the present embodiment, a table registering encryption scheme IDs associated with their corresponding encryption schemes may be stored in the ROM 23 or the NVRAM 24, for example.

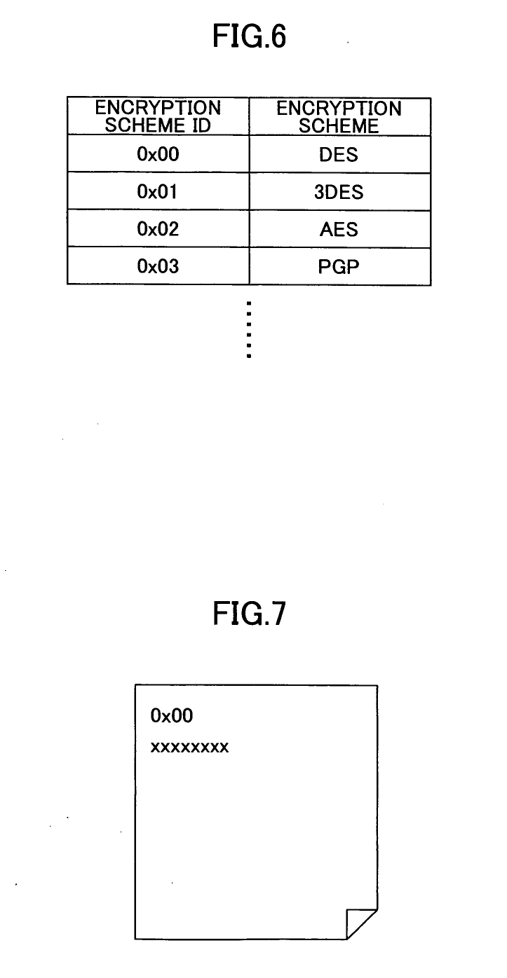

FIG. 6 is a table illustrating an example of encryption scheme IDs registered in association with their corresponding encryption schemes. In the table of FIG. 6, encryption scheme IDs 0x00, 0x01, 0x02, and 0x03 are registered in association with the encryption schemes DES, 3DES, AES, and PGP, respectively.

It is noted that the encryption scheme ID information may be recorded on the removable medium 5 by loading the removable medium 5 into the medium I/F 18, and recording the encryption scheme ID corresponding to the encryption scheme supported by the digital camera or image data managing software being used on the authentication information file 54 of the removable medium 5 through user operations directed by the user via the operations unit 20, for example.

In another embodiment, image data may be encrypted by the imaging apparatus. In this case, the removable medium 5 having image data stored therein may be loaded into the medium I/F 18 so that the stored image data may be encrypted by the imaging apparatus. After the image data are encrypted, the encryption scheme ID corresponding to the encryption scheme used in encrypting the image data may be recorded in the authentication information file 54, for example.

FIG. 7 is a diagram showing an example of the authentication information file 54 storing an encryption scheme ID. In the illustrated example of FIG. 7, the first one byte of the authentication information file 54 corresponds to an encryption scheme ID identifying an encryption scheme used for encrypting image data. In the present embodiment, the authentication unit 9 is configured to refrain from authenticating the removable medium 5 if the encryption scheme ID is not recorded in the authentication information file 54. Even if an encryption scheme ID is recorded in the authentication information file 54, the image data stored in the removable medium 5 may not be properly decrypted unless the recorded encryption scheme ID matches the encryption scheme ID stored in the relevant imaging apparatus. In this way, the image data stored in the removable medium 5 may be prevented from being read by imaging apparatuses other than the relevant imaging apparatus so that security of the image data may be ensured.

It is noted that in one preferred embodiment, a decryption key for decrypting the encrypted image data may be stored in the ROM 23 or the RAM, for example. The encrypted image data stored in the removable medium 5 may be decrypted by the decryption control unit 29.

In the following, authentication information according to another embodiment of the present invention is described.

According to the present embodiment, authentication information corresponds to group ID information identifying a predetermined group. A group ID may represent a department to which a relevant user belongs, or a group to which the removable medium 5 is assigned beforehand, for example.

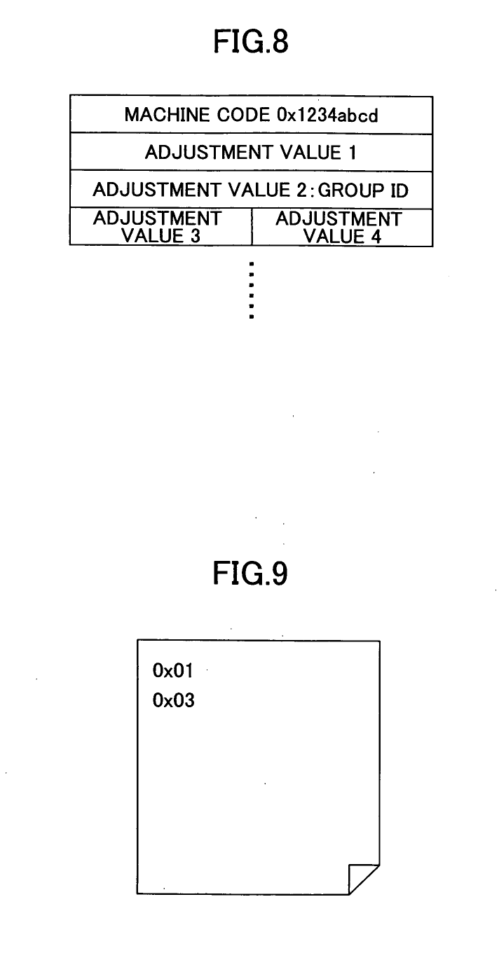

FIG. 8 is a table illustrating exemplary information including a group ID stored in the NVRAM 24. In the present example, a machine code and adjustment values are stored in the NVRAM 24 according to a predetermined format as in the example of FIG. 4, and a group ID is registered as the adjustment value 2.

It is noted that the group ID may be any type of ID information. In the present example, information items OzOA, 0x0B, 0x0C, and 0xoD are stored as exemplary group IDs. The imaging apparatus may authenticate the removable medium 5 that is loaded therein if the group ID stored in the authentication information file 54 of the removable medium 5 matches the group ID stored in the NVRAM 24 of the imaging apparatus.

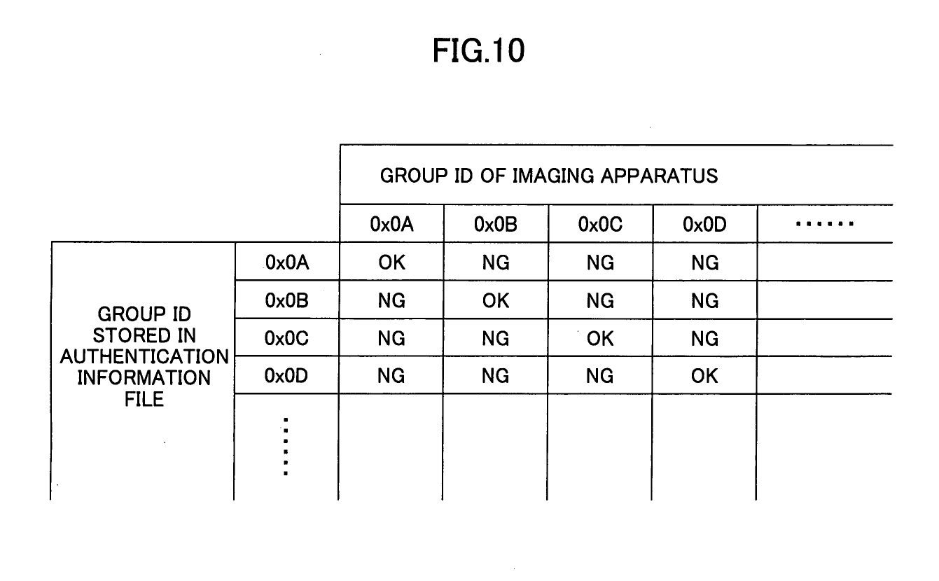

FIG. 9 is a diagram illustrating an example of the authentication information file 54 storing a group ID. As is shown in this drawing, plural group IDs may be stored in the authentication information file 54 according to the present example. FIG. 10 is a table representing determinations on whether to authenticate the removable medium 5 depending on whether the group ID stored in the authentication information file 54 matches the group ID stored in the NVRAM 24. In the table of FIG. 10, rows represent group IDs that may be stored in the authentication information file 54 and columns represent group IDs that may be stored in the imaging apparatus. Also, cases in which the removable medium 5 may be authenticated are indicated as ‘OK’ while cases in which the removable medium may not be authenticated are indicated as ‘NG’.

As is shown in FIG. 10, the removable medium 5 may be authenticated in a case where the authentication information file 54 has the group ID ‘0x0A’ stored therein and the NVRAM 24 of the imaging apparatus has the same group ID ‘0x0A’ stored therein. Similarly, the removable medium 5 may be authenticated when the authentication information file 54 has the group ID ‘0x0C’ stored therein and the NVRAM 24 of the imaging apparatus has the same group ID ‘0x0C’ stored therein.

As is described above, plural group IDs may be stored in the authentication information file 54 according to the present embodiment, and in such a case, the removable medium 5 may be authenticated by plural imaging apparatuses. According to the present embodiment, a user may be given printing authority according to the group ID assigned to the removable medium 5 so that security of image data stored in the removable image data may be ensured.

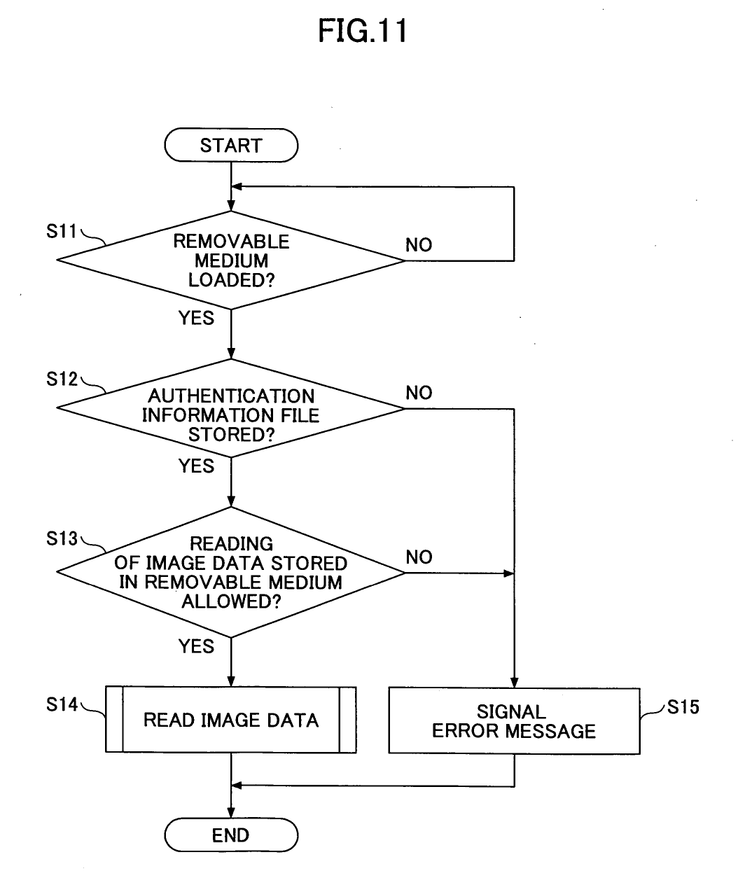

FIG. 11 is a flowchart illustrating an authentication process performed by an imaging apparatus for authenticating a removable medium according to an embodiment of the present invention.

According to the present embodiment, when a user loads a removable medium 5 into the medium I/F 18 of the imaging apparatus, a detection switch of the medium I/F 18 is turned on and the medium control unit 19 determines that the removable medium 5 has been loaded into the medium I/F 18 (step S11, YES). If the removable medium 5 is not loaded (step S11, NO), the imaging apparatus repeats the determination step S11. It is noted that in the present embodiment, the external apparatus 4 and the imaging apparatus may be interconnected through wired or wireless connection.

Then, the medium control unit 19 determines whether the authentication information file 54 is stored in a predetermined directory extending from the root directory 51 of the removable medium 5 (step S12). If the authentication information file 54 is not stored in the predetermined directory (step S12, NO), the medium control unit 19 signals an error message to the operations unit 20 to inform the user that the removable medium 5 cannot be authenticated (step S15). For example, the error message may be signaled by lighting a LED of the operations unit 20.

If the authentication information file 54 is stored in the predetermined directory (step S12, Yes), the authentication unit 9 performs an authentication process on the removable medium 5 and determines whether image data may be read from the removable medium 5 based on whether the authentication information stored in the authentication information file 54 matches the authentication information stored in the NVRAM 24 or ROM 23 as is described above (step S13).

Specifically, in the case where the authentication information corresponds to a machine code, the authentication unit 9 performs an authentication process on the removable medium 5 and determines whether image data may be read from the removable medium 5 based on whether the machine code stored in the authentication information file 54 matches the machine code stored in the NVRAM 24 or ROM 23 match. In the case where the authentication information corresponds to an encryption scheme ID, the authentication unit 9 performs an authentication process on the removable medium 5 and determines whether image data may be read from the removable medium 5 based on whether the encryption scheme ID stored in the authentication information file 54 matches the encryption scheme ID stored in the NVRAM 24 or ROM 23. In the case where the authentication information corresponds to a group ID, the authentication unit 9 performs an authentication process on the removable medium 5 and determines whether image data may be read from the removable medium 5 based on whether the group ID stored in the authentication information file 54 matches the group ID stored in the NVRAM 24 or RMA 23.

If the authentication information stored in the authentication information file 54 and the authentication information stored in the NVRAM 24 or ROM 23 do not match (step S13, NO), the authentication unit 9 signals an error message to the operations unit 20 to inform the user that the removable medium 5 cannot be authenticated (step S15). For example, the error message may be signaled by lighting a LED of the operations unit 20.

If the authentication information stored in the authentication information file 54 matches the authentication information stored in the NVRAM 24 or ROM 23 (step S13, YES), the imaging apparatus performs predetermined processes for reading the image data stored in the removable medium 5 (step S14). Specifically, in response to the authentication of the removable medium 5, the authentication unit 9 allows the medium control unit 19 to read image data stored in the removable medium 5. In turn, the medium control unit 19 reads image data designated by a read command from a corresponding directory such as the 100ABC directory 62, and transmits the read image data to the image write unit 27. In turn, the printer control unit 26 controls the printer engine 25 to print the read image data. It is noted that in the example of FIG. 11, an authentication process is performed on the removable medium 5 to control operations relating to reading image data from the removable medium 5; however, the authentication process may also be performed on the removable medium 5 to control operations relating to storing image data in the removable medium 5 according to another example.

As can be appreciated from the above descriptions, the imaging apparatus according to an embodiment of the present invention is configured to perform an authentication process on the removable medium 5 so that it may print image data stored in a digital camera while ensuring security of the image data. In a preferred embodiment, authentication information such as a machine code is recorded on the removable medium 5 and the authentication process is performed based on such authentication information so that security of image data may be ensured at a low cost.

Although the present invention is shown and described with respect to certain preferred embodiments, it is obvious that equivalents and modifications will occur to others skilled in the art upon reading and understanding the specification. The present invention includes all such equivalents and modifications, and is limited only by the scope of the claims.

The present application is based on and claims the benefit of the earlier filing date of Japanese Patent Application No. 2005-169411 filed on Jun. 9, 2005, the entire contents of which are hereby incorporated by reference.

What is claimed is:

1. An imaging apparatus comprising:
an authentication information storage unit configured to store first authentication information used for authenticating a storage medium;
an authentication unit configured to perform an authentication process on the storage medium based on second authentication information stored in the storage medium and the first authentication information stored in the authentication information storage unit; and
an access unit that is configured to perform at least one of reading digital data from the storage medium and writing the digital data on the storage medium when the authentication unit authenticates the storage medium.

2. The imaging apparatus as claimed in claim 1, wherein
the authentication unit authenticates the storage medium when the second authentication information matches the first authentication information.

3. The imaging apparatus as claimed in claim 1, wherein
the digital data correspond to image data captured by a solid-state image sensing device.

4. The imaging apparatus as claimed in claim 1, wherein
the first authentication information and the second authentication information correspond to imaging apparatus-specific code information.

5. The imaging apparatus as claimed in claim 1, wherein
the first authentication information and the second authentication information correspond to encryption scheme identification information that identifies an encryption scheme used for encrypting the digital data.

6. The imaging apparatus as claimed in claim 1, wherein
the first authentication information and the second authentication information correspond to group identification information that identifies a group to which the storage medium is assigned.

7. A storage medium comprising:
a tree-structure in which digital data are stored, the tree structure including a predetermined directory in which authentication information used by an imaging apparatus is stored.
